(19) United States
(12) Patent Application Publication
(10) Pub. No.: US 2017/0032121 A1
(43) Pub. Date: Feb. 2, 2017

(54) METHOD AND APPARATUS FOR DETECTING LOADING OF LIBRARY

(71) Applicant: ELECTRONICS AND TELECOMMUNICATIONS RESEARCH INSTITUTE, Daejeon (KR)

(72) Inventors: Eunyoung KIM, Daejeon (KR); Jaehun LEE, Daejeon (KR); Jinmo PARK, Daejeon (KR); Minho KIM, Daejeon (KR); Yosik KIM, Daejeon (KR)

(21) Appl. No.: 14/934,999

(22) Filed: Nov. 6, 2015

(30) Foreign Application Priority Data
Jul. 31, 2015 (KR) 10-2015-0108978

(51) Int. Cl. G06F 21/56

(52) U.S. Cl. CPC G06F 21/56

(57) ABSTRACT

A method and apparatus for detecting the loading of a library. A binary loading monitoring unit monitors loading of a binary. A first DLL filtering unit detects a duplicate DLL or a nonexistent DLL that does not exist in a file path among one or more DLLs to be loaded by the binary, and processes the duplicate DLL or the nonexistent DLL. A second DLL filtering unit detects an unused DLL among the one or more DLLs and processes the unused DLL.

### CROSS REFERENCE TO RELATED APPLICATION

This application claims the benefit of Korean Patent Application No. 10-2015-0108978, filed Jul. 31, 2015, which is hereby incorporated by reference in its entirety into this application.

### BACKGROUND OF THE INVENTION

1. Technical Field

The following embodiments generally relate to a method and apparatus for detecting the loading of a library and, more particularly, to a method and apparatus for detecting the loading of a dynamic library for anticipatory execution.

2. Description of the Related Art

Among hacking techniques used to break into computer systems, a Dynamic Link Library (DLL) preloading technique is present.

DLL preloading is a technique for causing an application to load a malicious DLL file, erroneously recognized as a normal DLL file, when the application loads a DLL file. An attacker enables malicious code to be automatically installed and executed on a computer system using a nonexistent file name.

When a malicious DLL file is loaded, malicious code in the malicious DLL file may be automatically executed. In other words, DLL preloading is a technique for causing a binary that must not be loaded to be loaded by a developer's mistake.

For example, when a DLL is registered in a predetermined registry, the Operating System (OS) of a computer system may provide a function of loading a DLL in which all processes of the computer system are registered. A large number of pieces of malicious code may easily inject a DLL into an antivirus process using this function, and may terminate the malicious DLL loaded by DLL injection before the process is initialized after DLL injection.

In relation to DLL preloading, Korean Patent Application Publication No. 10-2014-0023459 is disclosed. More specifically, Korean Patent Application Publication No. 10-2014-0023459 discloses technology whereby a malicious DLL is prevented from being loaded into an antivirus process due to DLL injection, and a malicious DLL is also prevented from being loaded into a normal process.

### SUMMARY OF THE INVENTION

Accordingly, an embodiment of the present disclosure is intended to provide a method and apparatus that detect potential binary preloading vulnerabilities in advance and notify a user of the detected potential binary preloading vulnerabilities.

Another embodiment of the present disclosure is to provide a method and apparatus that eliminate a potential binary preloading vulnerability via the deletion of a DLL and the unloading of a DLL.

In accordance with an aspect, there is provided a method for detecting loading of a library, including monitoring loading of a binary; detecting a duplicate Dynamic Link Library (DLL) or a nonexistent DLL that does not exist in a file path among one or more DLLs to be loaded by the binary; and processing the duplicate DLL or the nonexistent DLL.

The method may further include determining whether the binary loads a DLL, wherein detecting and processing are performed when the binary is a library that loads a DLL.

Detecting the duplicate DLL or the nonexistent DLL may include generating a list of the one or more DLLs by analyzing the binary; and collecting file paths in which each DLL in the list exists; and if the DLL exists in two or more file paths, selecting the DLL as the duplicate DLL.

The duplicate DLL may be classified into a normal duplicate DLL and an abnormal duplicate DLL, and if the DLL exists in two or more file paths and is a normal system duplicate file, the DLL may be a normal duplicate DLL.

The method may further include updating a list of normal system duplicate files via interaction with an update server.

The duplicate DLL may be classified into a normal duplicate DLL and an abnormal duplicate DLL, and if the DLL exists in two or more file paths and all of the two or more file paths are normal system duplicate paths, the DLL may be a normal duplicate DLL.

The method may further include updating a list of normal system duplicate paths via interaction with an update server.

The duplicate DLL may be classified into a normal duplicate DLL and an abnormal duplicate DLL, and if the DLL is not a normal system duplicate file, and at least one of the two or more file paths in which the DLL exists is not a normal system duplicate path, the DLL may be an abnormal duplicate DLL.

The file paths in which it is checked whether the DLL exists may include system check paths.

The method may further include updating a list of the system check paths via interaction with an update server.

Detecting the duplicate DLL or the nonexistent DLL may include generating a list of one or more DLLs by analyzing the binary; collecting file paths in which each DLL in the list exists; and selecting the DLL as the nonexistent DLL if any file path in which the DLL exists is not collected.

Processing the duplicate DLL or the nonexistent DLL may include deleting the duplicate DLL or the nonexistent DLL that does not exist in any file path.

Processing the duplicate DLL or the nonexistent DLL may include outputting information about the duplicate DLL or the nonexistent DLL; and receiving a request to delete the duplicate DLL or the nonexistent DLL.

In accordance with another aspect, there is provided a method for detecting loading of a library, including monitoring loading of a binary; detecting an unused Dynamic Link Library (DLL) among one or more DLLs to be loaded by the binary; and processing the unused DLL, wherein the unused DLL is a library that does not have functions called by the binary.

Detecting the unused DLL may include determining a certain DLL to be the unused DLL if any of one or more functions to be used by the binary is not present in the certain DLL.

The one or more functions to be used by the binary may be functions actually called by the binary.

Processing the unused DLL may include unloading the unused DLL.

Processing the unused DLL may further include outputting information about the unused DLL; and receiving a request to unload the unused DLL.

In accordance with a further aspect, there is provided an apparatus for detecting loading of a library, including a binary loading monitoring unit for monitoring loading of a binary; and a first DLL filtering unit for detecting a duplicate DLL or a nonexistent DLL that does not exist in a file path among one or more DLLs to be loaded by the binary, and processing the duplicate DLL or the nonexistent DLL.

The apparatus may further include a second DLL filtering unit for detecting an unused DLL among the one or more DLLs and processing the unused DLL.

In addition, there are provided other methods, devices, and systems for implementing the present disclosure, and a computer-readable storage medium storing a computer program for executing the method.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing an apparatus for detecting the loading of a library according to an embodiment;

FIG. 2 is a flowchart showing a method for detecting the loading of a library according to an embodiment;

FIG. 3 is a flowchart showing a method for detecting a duplicate DLL or a DLL that does not exist in a file path according to an embodiment;

FIG. 4 is a flowchart showing a method for processing a duplicate DLL and a DLL that does not exist in a file path according to an embodiment;

FIG. 5 is a flowchart showing a method for detecting an unused DLL according to an embodiment;

FIG. 6 is a flowchart showing a method for processing an unused DLL according to an embodiment;

FIG. 7 is a diagram showing a list of one or more DLLs to be loaded by a binary according to an embodiment;

FIG. 8 is a diagram showing classification as duplicate DLLs and as a nonexistent DLL according to an embodiment;

FIG. 9 is a diagram showing a list of one or more functions used by a binary according to an embodiment;

FIG. 10 is a diagram showing classification as an unused DLL according to an embodiment;

FIG. 11 is a flowchart showing a database (DB) update method according to an embodiment;

FIG. 12 is a diagram showing the schema of a normal system duplicate file DB according to an embodiment; and

FIG. 13 is a diagram showing the schema of a system check path DB according to an embodiment.

### DESCRIPTION OF THE PREFERRED EMBODIMENTS

The following detailed descriptions of the present invention will be made with reference to the attached drawings that illustrate specific embodiments in which the present invention can be practiced. These embodiments will be described in detail so that those skilled in the art can sufficiently practice the present invention. It should be understood that various embodiments of the present invention may differ, but they do not need to be exclusive. For example, specific shapes, structures and characteristics described herein in an embodiment may be implemented in various manners in other embodiments without departing from the spirit and scope of the present invention. Further, it should be understood that the locations and arrangements of individual elements in each disclosed embodiment may be changed without departing from the spirit and scope of the present invention. Therefore, the following detailed descriptions are not intended to limit the present disclosure, and the scope of the present invention should be limited only by the accompanying claims along with all equivalent scopes of the claims as long as it is suitably described. The same or similar reference numerals are used to designate the same or similar elements or functions throughout the drawings.

Hereinafter, exemplary embodiments of the present invention will be described in detail with reference to the attached drawings so that those skilled in the art to which the present invention pertains can easily practice the present invention.

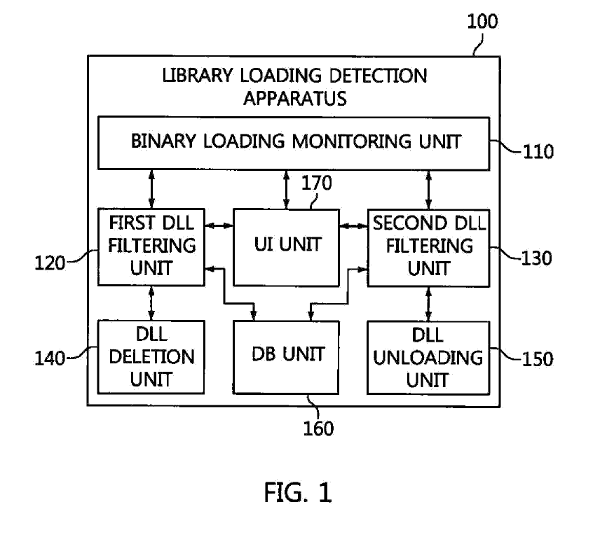

FIG. 1 is a configuration diagram showing an apparatus for detecting the loading of a library according to an embodiment.

The library loading detection apparatus 100 may detect the automatic loading of a dynamic library for anticipatory execution.

The library loading detection apparatus 100 may include a binary loading monitoring unit 110, a first DLL filtering unit 120, a second DLL filtering unit 130, a DLL deletion unit 140, a DLL unloading unit 150, a database (DB) unit 160, and a user interface (UI) unit 170.

The library loading detection apparatus 100 may be a device identical to a computer system for executing a binary, and may be a part of the computer system.

The library loading detection apparatus 100 detects the danger of a DLL preloading attack on a DLL loaded by a binary, and may perform DLL processing to eliminate the danger when the possibility of a DLL preloading attack is detected.

The binary loading monitoring unit 110 may be a module for detecting the execution of a binary on the computer system. The binary loading monitoring unit 110 may monitor the execution of a binary so as to detect the presence of a binary preloading vulnerability before the execution of the binary. The binary loading monitoring unit 110 may monitor the execution of a binary in real time or in non-real time.

For example, the binary loading monitoring unit 110 may detect the execution of a binary by monitoring a “LoacilLibrary” function.

When the execution of a binary is detected, the first DLL filtering unit 120 may generate a list of one or more DLLs to be loaded by the binary. The first DLL filtering unit 120 may detect a duplicate DLL or a DLL that does not exist in a file path (hereinafter also referred to as a “nonexistent DLL”) among the one or more DLLs to be loaded by the binary.

The first DLL filtering unit 120 is configured to, when a duplicate DLL or a DLL that does not exist in a file path is detected, notify the user of the computer system of the potential binary preloading vulnerability.

Further, the second DLL filtering unit 130 may detect an unused DLL among the one or more DLLs to be loaded by a binary.

The second DLL filtering unit 130 is configured to, when an unused DLL is detected, notify the user of the computer system of the potential binary preloading vulnerability.

The first DLL filtering unit 120 and the second DLL filtering unit 130 may detect potential DLL preloading vulnerabilities via dual checking of the DLLs to be loaded by a binary, and eliminate the detected potential DLL preloading vulnerabilities.

The DLL deletion unit 140 may delete a DLL.

For example, the first DLL filtering unit 120 may transmit a request to delete a duplicate DLL or a DLL that does not exist in a file path to the DLL deletion unit 140. The DLL deletion unit 140 may delete the DLL that has been requested to be deleted, that is, the duplicate DLL or the DLL that does not exist in a file path.

The DLL unloading unit 150 may unload a DLL.

For example, the second DLL filtering unit 130 may transmit a request to unload an unused DLL to the DLL unloading unit 150. The DLL unloading unit 150 may unload an unused DLL that has been requested to be unloaded.

The DB unit 160 may provide DBs. The DBs may be used by the first DLL filtering unit 120 and the second DLL filtering unit 130.

For example, the DBs may include a system check path DB, a normal system duplicate file DB, and a normal system duplicate path DB.

The first DLL filtering unit 120 may use the system check path DB upon detecting a duplicate DLL or a DLL that does not exist in a file path. Further, the first DLL filtering unit 120 may use the normal system duplicate file DB and the normal system duplicate path DB when it detects a duplicate DLL.

The UI unit 170 may output information related to the operation of the library loading detection apparatus 100, or may receive the information from the user of the library loading detection apparatus 100.

For example, the UI unit 170 may output information requested by the first DLL filtering unit 120 and the second DLL filtering unit 130, and may transmit the received information to the first DLL filtering unit 120 and the second DLL filtering unit 130.

The UI unit 170 may provide the user with information indicating that a potential binary preloading vulnerability is present.

As shown in FIG. 1, the library loading detection apparatus 100 according to the embodiment may include the binary loading monitoring unit 110, the first DLL filtering unit 120, the second DLL filtering unit 130, the DLL deletion unit 140, the DLL unloading unit 150, the DB unit 160, and the UI unit 170. In accordance with an embodiment, some of the binary loading monitoring unit 110, the first DLL filtering unit 120, the second DLL filtering unit 130, the DLL deletion unit 140, the DLL unloading unit 150, the DB unit 160, and the UI unit 170 may be program modules, and may communicate with an external device or an external system. Such program modules may be included in the library loading detection apparatus 100 in the form of an operating system, an application program module, and an additional program module, and may be physically stored in various types of well-known storage devices. Further, at least some of the program modules may be stored in a remote storage device capable of communicating with the library loading detection apparatus 100. Such program modules may include, but are not limited to, a routine, a subroutine, a program, an object, a component, and a data structure for performing specific functions or operations, which will be described later, or for executing specific abstract data types. Each of the program modules may be implemented using instructions or codes that are executed by at least one processor of the library loading detection apparatus 100.

Further, the program modules may be used as independent programs, or may be additionally installed in other security programs, such as an antivirus program or a firewall. Such program modules may be executed as subordinate modules in the form of plug-in programs.

For example, the binary loading monitoring unit 110 may be triggered by the operating system or the like of the computer system when a binary execution event or a binary loading event occurs on the computer system.

The operations and functions of the binary loading monitoring unit 110, the first DLL filtering unit 120, the second DLL filtering unit 130, the DLL deletion unit 140, the DLL unloading unit 150, the DB unit 160, and the UI unit 170 of the library loading detection apparatus 100 will be described below.

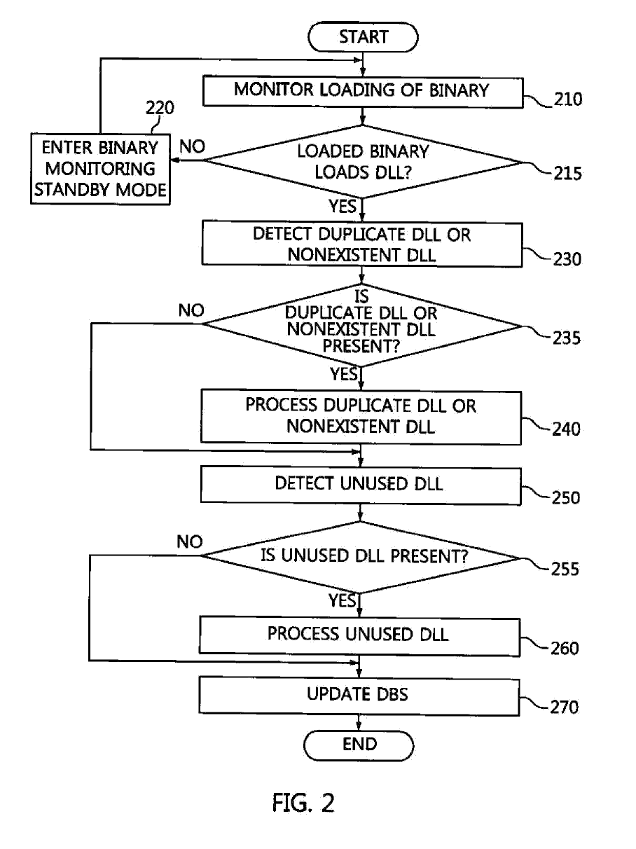

FIG. 2 is a flowchart showing a method for detecting the loading of a library according to an embodiment.

At step 210, when a binary is loaded into the computer system, the binary loading monitoring unit 110 may monitor the loading of the binary.

At step 215, when the loading of the binary is monitored, the binary loading monitoring unit 110 may determine whether the loaded binary loads any DLL.

If it is determined at step 215 that the loaded binary does not load any DLL, the possibility of a DLL preloading attack caused by a DLL is not present. Therefore, steps 230, 235, 240, 250, 255, 260, and 270 related to the detection of library loading, which will be described later, do not need to be performed, and step 220 may be performed.

When the loaded binary loads at least one DLL, step 230 may be performed. In other words, all or some of steps 230, 235, 240, 250, 255, 260, and 270, which will be described later, may be performed when the loaded binary is a library that loads at least one DLL.

At step 220, the binary loading monitoring unit 110 may enter a binary monitoring standby mode. When another binary is loaded into the computer system, step 210 may be performed again.

Below, two-stage detection of binary preloading vulnerabilities may be performed by the first DLL filtering unit 120 and the second DLL filtering unit 130.

At step 230, the first DLL filtering unit 120 may detect a duplicate DLL or a DLL that does not exist in a file path among one or more DLLs to be loaded by the binary.

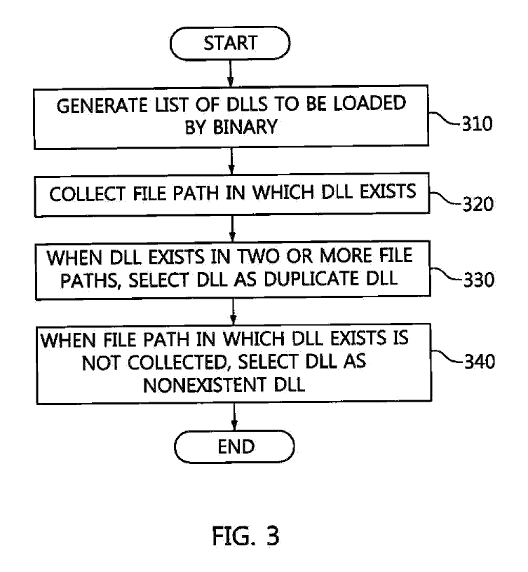

The detection of a duplicate DLL and a DLL that does not exist in a file path according to an embodiment will be described in detail later with reference to FIG. 3.

At step 235, the first DLL filtering unit 120 may check whether a duplicate DLL or a DLL that does not exist in a file path is present among the one or more DLLs. When a duplicate DLL or a DLL that does not exist in a file path is present among the one or more DLLs, step 240 may be performed. When a duplicate DLL or a DLL that does not exist in a file path is not present among the one or more DLLs, step 250 may be performed.

At step 240, the first DLL filtering unit 120 may process a duplicate DLL or a DLL that does not exist in a file path. Here, the processing of the DLL may be intended to prevent the occurrence of a DLL preloading vulnerability.

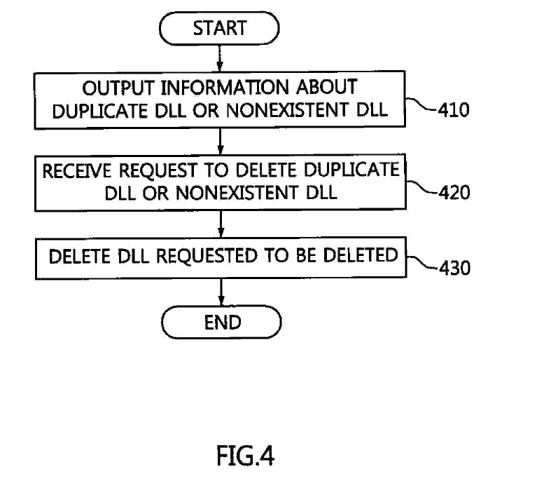

The processing of a duplicate DLL and a nonexistent DLL according to an embodiment will be described in detail later with reference to FIG. 4.

At step 250, the second DLL filtering unit 130 may detect an unused DLL among the one or more DLLs to be loaded by the binary.

The unused DLL may be a library having no functions called by the binary.

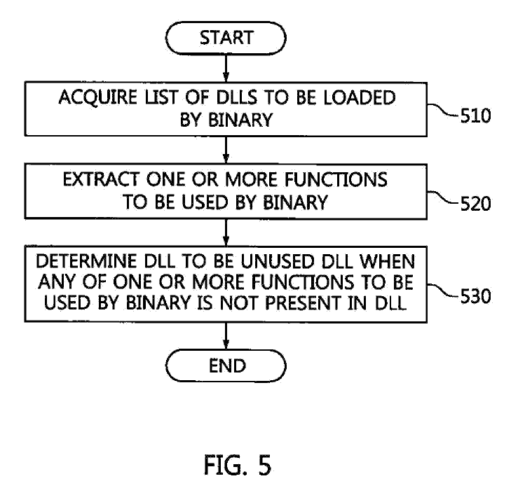

The detection of an unused DLL according to an embodiment will be described in detail later with reference to FIG. 5.

At step 255, the second DLL filtering unit 130 may check whether an unused DLL is present among the one or more DLLs to be loaded by the binary. When any unused DLL is present, step 260 may be performed. In contrast, when no unused DLL is present, step 270 may be performed.

At step 260, the second DLL filtering unit 130 may perform the processing of the unused DLL. The processing of the unused DLL may be intended to prevent the occurrence of a DLL preloading vulnerability.

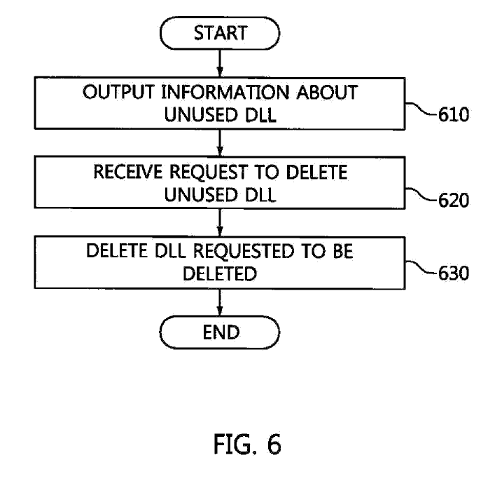

The processing of an unused DLL according to an embodiment will be described in detail later with reference to FIG. 6.

At step 270, the DB unit 160 may update the DBs. The updated DBs may be used when steps 230, 235, 240, 250, 255, and 260 are repeated again.

The update of the DBs may be performed in a centralized manner. Further, the update of the DBs may be performed via a distributed technique.

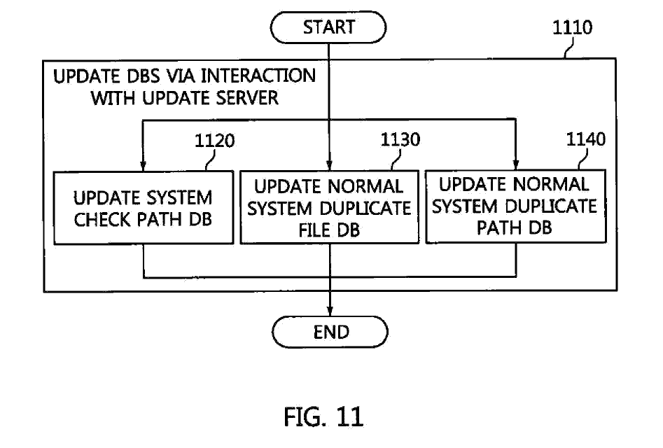

The update of DBs according to an embodiment will be described in detail with reference to FIG. 11.

The execution sequence of step 270 is only an exemplary embodiment, and may be performed simultaneously with other steps 210, 215, 220, 230, 235, 240, 250, 255, and 260. Further, step 270 may also be performed between two of the other steps 210, 215, 220, 230, 235, 240, 250, 255, and 260.

After the procedure has been performed, step 220 may also be performed again, and step 210 may be performed with the loading of the binary.

FIG. 3 is a flowchart showing a method for detecting a duplicate DLL or a DLL that does not exist in a file path (nonexistent DLL) according to an embodiment.

Step 230, described above with reference to FIG. 2, may include the following steps 310, 320, 330, and 340.

At step 310, the first DLL filtering unit 120 may generate a list of one or more DLLs to be loaded by a binary by analyzing the binary.

Further, the list may include one or more additional executable files. In other words, the first DLL filtering unit 120 may generate the list of one or more DLLs to be loaded by the binary and executable files by analyzing the binary. Here, the executable files may be binary files other than DLLs. Below, the description of DLLs also applies to executable files, and “one or more DLLs” may be replaced with “one or more DLLs and executable files”.

When the list of one or more DLLs to be loaded by the binary is generated, the first DLL filtering unit 120 may perform the following steps 320, 330, and 340 for each DLL in the list. Hereinafter, each DLL in the list is referred to as a “target DLL”.

At step 320, the first DLL filtering unit 120 may collect file paths in which a target DLL in the list exists.

The first DLL filtering unit 120 may check whether a target DLL exists in one or more predetermined file paths. For example, the file paths in which it is checked whether a target DLL exists may include a system check path.

Such a system check path may be a path in which the automatic loading of a DLL into the computer system is performed. The system check path may include multiple paths.

At step 320, the first DLL filtering unit 120 may request a system check path DB from the DB unit 160, and the DB unit 160 may provide the system check path DB to the first DLL filtering unit 120. The system check path DB may include a list of system check paths.

When the first DLL filtering unit 120 uses the list of system check paths, the efficiency of search and detection by the first DLL filtering unit 120 may be improved.

At step 330, when the target DLL exists in two or more file paths, the first DLL filtering unit 120 may select the target DLL as a duplicate DLL.

Duplicate DLLs may be classified into normal duplicate DLLs and abnormal duplicate DLLs. The first DLL filtering unit 120 may determine that the target DLL is one of a normal duplicate DLL and an abnormal duplicate DLL depending on a predetermined condition.

If the target DLL exists in two or more file paths and is a normal system duplicate file, the first DLL filtering unit 120 may determine that the target DLL is a normal duplicate DLL.

Even in a normal computer system, duplicate DLL files may be present therein. Such a normal system duplicate file may be a file that may be duplicated even in a normal computer system. Such a normal system duplicate file may include multiple files.

At step 330, the first DLL filtering unit 120 may request a normal system duplicate file DB from the DB unit 160, and the DB unit 160 may provide the normal system duplicate file DB to the first DLL filtering unit 120. The normal system duplicate file DB may include a list of normal system duplicate files.

The list of normal system duplicate files may be a whitelist obtained via filtering by the first DLL filtering unit 120. As the first DLL filtering unit 120 uses the list of normal system duplicate files, the incidence of false positives from the first DLL filtering unit 120 may be reduced.

When the target DLL exists in two or more file paths, and all of the two or more file paths are normal system duplicate paths, the first DLL filtering unit 120 may determine that the target DLL is a normal duplicate DLL.

Even in a normal computer system, duplicate DLL files may be present therein. Such a normal system duplicate path may be a path in which DLLs may be duplicated and present even in a normal computer system. For example, the presence of a DLL in a normal system duplicate path may be excluded from the objects to be taken into consideration upon determining whether the corresponding DLL is an abnormal duplicate DLL.

At step 330, the first DLL filtering unit 120 may request a normal system duplicate path DB from the DB unit 160, and the DB unit 160 may provide the normal system duplicate path DB to the first DLL filtering unit 120. The normal system duplicate path DB may include a list of normal system duplicate paths.

The list of normal system duplicate paths may be a whitelist obtained via filtering by the first DLL filtering unit 120. Because the first DLL filtering unit 120 uses the list of normal system duplicate paths, the incidence of false positives from the first DLL filtering unit 120 may be reduced.

When the target DLL is not a normal system duplicate file and at least one of two or more file paths, in which the target DLL exists, is not a normal system duplicate path, the first DLL filtering unit 120 may determine that the target DLL is an abnormal duplicate DLL.

Normal duplicate DLLs may be excluded from the objects to be processed at step 240. In other words, the term “duplicate DLL” at steps 230 and 240 may indicate only an abnormal duplicate DLL, among both normal duplicate DLLs and abnormal duplicate DLLs.

At step 340, if any file path in which the target DLL exists is not collected, the first DLL filtering unit 120 may select the target DLL as a nonexistent DLL.

FIG. 4 is a flowchart showing a method for processing a duplicate DLL and a nonexistent DLL according to an embodiment.

Step 240, described above with reference to FIG. 2, may include the following steps 410, 420, and 430.

At step 410, the first DLL filtering unit 120 may request the UI unit 170 to output information about a duplicate DLL or a DLL that does not exist in a file path (nonexistent DLL), and the UI unit 170 may output the information about the duplicate DLL or the nonexistent DLL.

The UI unit 170 may notify the user that there is a potential binary pre loading vulnerability by outputting the information about the duplicate DLL or the nonexistent DLL.

When the information about the duplicate DLL or the nonexistent DLL is output, the user of the computer system or the library loading detection apparatus 100 may determine how to process the duplicate DLL or the nonexistent DLL. In other words, whether to load the duplicate DLL or the nonexistent DLL may be determined by the user.

For example, when a list of duplicate DLLs or nonexistent DLLs is output, DLLs to be deleted may be selected from among the DLLs in the output list.

At step 420, the UI unit 170 may receive a request, which is input by the user, to delete a duplicate DLL or a nonexistent DLL that does not exist in a file path. The UI unit 170 may transmit the received request to the DLL deletion unit 140.

At step 430, the DLL deletion unit 140 may delete a DLL that has been requested to be deleted, that is, a duplicate DLL or a nonexistent DLL.

Alternatively, at step 420, the UI unit 170 may receive a request, which is input by the user, to tolerate a duplicate DLL. The UI unit 170 may transmit the received request to the DLL deletion unit 140. At step 430, the DLL deletion unit 140 may delete a DLL that has not been requested to be tolerated, that is, a duplicate DLL or a nonexistent DLL.

By means of the reception of the user request at step 420, whether to load a duplicate DLL or to delete a duplicate DLL may be determined by the user.

By forcibly deleting duplicate DLLs or nonexistent DLLs at step 430, potential binary preloading vulnerabilities caused by duplicate DLLs or nonexistent DLLs may be eliminated.

FIG. 5 is a flowchart showing a method for detecting an unused DLL according to an embodiment.

Step 250, described above with reference to FIG. 2, may include the following steps 510, 520, and 530.

At step 510, the second DLL filtering unit 130 may acquire a list of one or more DLLs to be loaded by the binary, the list being generated at step 310, described above with reference to FIG. 3. Alternatively, the second DLL filtering unit 130 may generate a list of one or more DLLs to be loaded by the binary by analyzing the binary.

At step 520, the second DLL filtering unit 130 may extract one or more functions to be used by the binary. Further, the second DLL filtering unit 130 may generate a list of one or more functions to be used by the binary. Here, the one or more functions to be used by the binary may be functions that are actually called by the binary.

The execution sequence of steps 510 and 520 shown in FIG. 5 may be only an exemplary embodiment.

The second DLL filtering unit 130 may perform the following step 530 for each DLL in the list. Hereinafter, each DLL in the list is referred to as a “target DLL”.

At step 530, the second DLL filtering unit 130 may determine that the target DLL is an unused DLL when any of one or more functions to be used by the binary is not present in the target DLL.

The target DLL may include one or more functions. The second DLL filtering unit 130 may generate a list of one or more functions of the target DLL, and the list of one or more functions to be used by the binary may be compared with the list of one or more functions of the target DLL. If a common function is present both in the list of one or more functions to be used by the binary and in the list of one or more functions of the target DLL, the second DLL filtering unit 130 may determine that the target DLL is not an unused DLL. In contrast, if a common function is not present both in the list of one or more functions to be used by the binary and in the list of one or more functions of the target DLL, the second DLL filtering unit 130 may determine that the target DLL is an unused DLL.

FIG. 6 is a flowchart showing a method for processing an unused DLL according to an embodiment.

At step 610, the second DLL filtering unit 130 may request the UI unit 170 to output information about unused DLLs, and the UI unit 170 may output the information about unused DLLs.

The UI unit 170 may notify the user that a potential binary preloading vulnerability is present by outputting the information about unused DLLs.

When the information about unused DLLs is output, the user of the computer system or the library loading detection apparatus may determine how to process the unused DLLs.

For example, when the list of unused DLLs is output, the user may select a DLL to be unloaded from among the DLLs in the output list.

At step 620, the UI unit 170 may receive a request, which is input by the user, to unload an unused DLL. The UI unit 170 may transmit the received request to the DLL unloading unit 150.

At step 630, the DLL unloading unit 150 may unload the unused DLL that has been requested to be unloaded.

By means of forcible unloading of the unused DLL at step 630, the potential binary preloading vulnerabilities caused by the unused DLL may be eliminated.

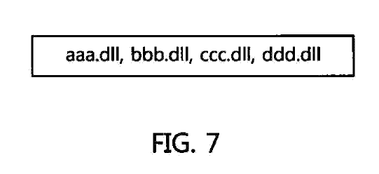

FIG. 7 is a diagram showing a list of one or more DLLs to be loaded by a binary according to an embodiment.

In FIG. 7, the list of DLLs shown in FIG. 7 may be a list of one or more DLLs to be loaded by the binary, the list being generated by the first DLL filtering unit 120 at step 310.

As shown in the drawing, four DLLs are detected as DLLs to be loaded by the binary.

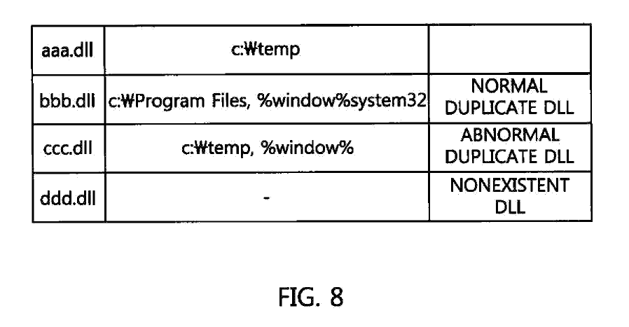

FIG. 8 illustrates classification as duplicate DLLs and as a nonexistent DLL according to an embodiment.

As described above with reference to FIG. 3, steps 320, 330, and 340 may be performed on each of multiple DLLs shown in FIG. 7.

In FIG. 8, the first column indicates the names of DLLs, and the second column indicates the paths in which respective DLLs have been detected. The third column indicates the types of respective DLLs classified by the first DLL filtering unit 120.

“aaa.dll” was detected only in the path “c:\temp”. Therefore, “aaa.dll” may not be classified as a duplicate DLL or a nonexistent DLL.

“bbb.dll” was detected in the paths “c:\Program Files” and “%windows%system32”. Both the paths “c:\Program Files” and “%windows%system32” may be normal system duplicate paths. Therefore, “bbb.dll” may be classified as a normal duplicate DLL.

“ccc.dll” was detected both in the paths “c:\temp” and “%windows%”. Of the paths “c:\temp” and “%windows%”, “c:\temp” may not be a normal system duplicate path. Therefore, “ccc.dll” may be classified as an abnormal duplicate DLL.

“ddd.dll” was not detected in any paths. Therefore, “ddd.dll” may be classified as a nonexistent DLL.

At step 410, described above with reference to FIG. 4, the first DLL filtering unit 120 and the UI unit 170 may output information, such as that shown in FIG. 8, for one or more DLLs to be loaded by a binary.

As shown in FIG. 8, the first DLL filtering unit 120 and the UI unit 170 may notify the user that a potential binary preloading vulnerability is present due to the abnormal duplicate DLL, that is, “ccc.dll” and the nonexistent DLL, that is, “ddd.dll”.

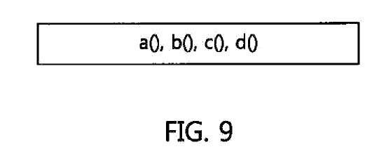

FIG. 9 illustrates a list of one or more functions to be used by a binary according to an embodiment.

The list of functions shown in FIG. 9 may include one or more functions to be used by the binary, the functions being extracted by the second DLL filtering unit 130 at step 520.

As shown in the drawing, four functions are extracted as functions to be used by the binary.

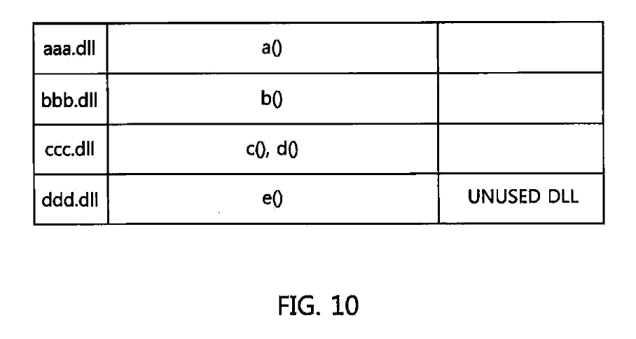

FIG. 10 illustrates classification as an unused DLL according to an embodiment.

Below, when four DLLs shown in FIG. 7 are detected as DLLs to be loaded by a binary, whether each of the detected DLLs is an unused DLL is indicated in the drawing.

In FIG. 10, the first column indicates the names of the DLLs. The second column indicates a list of one or more functions of each DLL. The third column indicates the types of respective DLLs classified by the second DLL filtering unit 130.

“aaa.dll” includes “a( )”. “a( )” is one of the functions to be used by the binary. Therefore, “aaa.dll” may not be classified as an unused DLL.

“bbb.dll” include “b( )”. “b( )” is one of the functions to be used by the binary. Therefore, “bbb.dll” may not be classified as an unused DLL.

“ccc.dll” includes “c( )” and “d( )”. Both “c( )” and “d( )” are functions to be used by the binary. Therefore, “ccc.dll” may not be classified as an unused DLL.

“ddd.dll” includes “e( )”. “e( )” is not one of the functions to be used by the binary. Further, “ddd.dll” includes none of the one or more functions to be used by the binary. Therefore, “ddd.dll” may be classified as an unused DLL.

At step 610, described above with reference to FIG. 6, the second DLL filtering unit 130 and the UI unit 170 may output information, such as that shown in FIG. 10, for one or more DLLs to be loaded by the binary.

As shown in FIG. 10, the second DLL filtering unit 130 and the UI unit 170 may notify the user that a potential binary preloading vulnerability is present due to the unused DLL, that is, “ddd.dll”.

FIG. 11 is a flowchart showing a DB update method according to an embodiment.

Step 270, described above with reference to FIG. 2, may include step 1110.

At step 1110, the DB unit 160 may update DBs via interaction with an update server.

The DB unit 160 may update at least one of a system check path DB, a normal system duplicate file DB, and a normal system duplicate path DB via interaction with the update server.

Step 1110 may include step 1120, step 1130, and step 1140. When step 1110 is performed, at least one of steps 1120, 1130, and 1140 may be performed.

At step 1120, the DB unit 160 may update the system check path DB.

The DB unit 160 may update the list of system check paths in the system check path DB via interaction with the update server.

At step 1130, the DB unit 160 may update the normal system duplicate file DB.

The DB unit 160 may update the list of normal system duplicate files in the normal system duplicate file DB via interaction with the update server.

At step 1140, the DB unit 160 may update the normal system duplicate path DB.

The DB unit 160 may update the list of normal system duplicate paths in the normal system duplicate path DB via interaction with the update server.

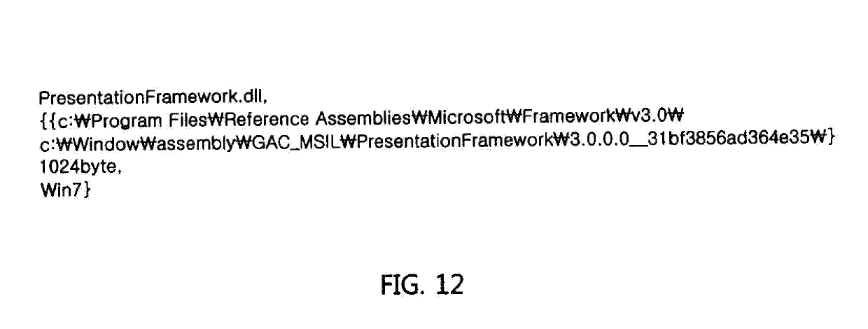

FIG. 12 illustrates the schema of the normal system duplicate file DB according to an embodiment.

As shown in FIG. 12, the schema of the normal system duplicate file DB may include the file name, a list of file paths, the file size, and the version of the operating system.

The normal system duplicate file DB may be a whitelist of files that may normally be duplicated in the computer system.

In FIG. 12, “PresentationFramework.dll” denotes a file name. “c:\Program Files\Reference Assemblies\Microsoft\Framework\v3.0\” and “c:\Windows\assembly\GAC_MSIL\PresentationFramework\3.0.0.0_31bf3856ad364e35\” each denote a file path. “1024 byte” indicates that the size of the file is 1024 bytes. “Win7” denotes the version of the OS.

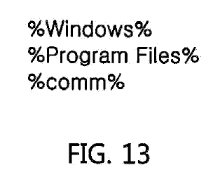

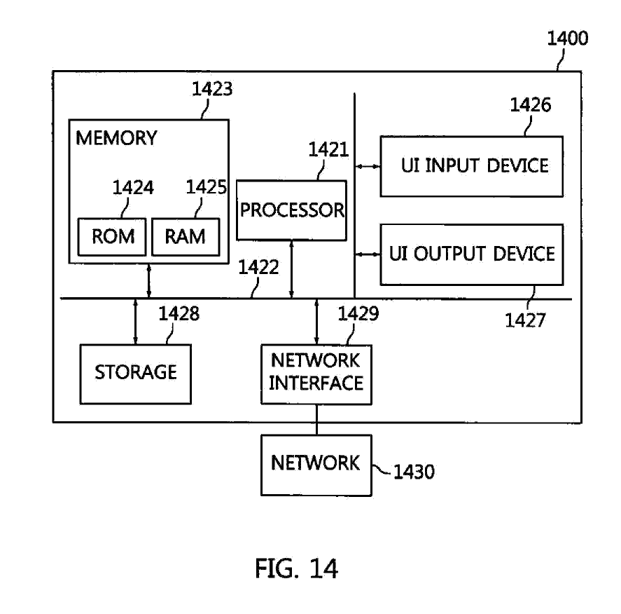

FIG. 13 illustrates the schema of the system check path DB according to an embodiment.

The schema of the system check path DB may indicate a system check path. The schema of the system check path DB may include at least one system check path.

In FIG. 13, as the system check paths, “%windows%” “%Program Files”, and “%comm%” are illustrated.

FIG. 14 illustrates an electronic device in which the library loading detection apparatus according to an embodiment is implemented.

A library loading detection apparatus 100 may be implemented in an electronic device 1400, shown in FIG. 14.

The library loading detection apparatus 100 may be implemented on a computer system including a computer-readable storage medium. As shown in FIG. 14, the electronic device 1400 may include at least one processor 1421, memory 1423, a User Interface (UI) input device 1426, a UI output device 1427, and storage 1428, which communicate with each other through a bus 1422. The electronic device 1400 may further include a network interface 1429 connected to a network 1430. The processor 1421 may be a semiconductor device for executing processing instructions stored in a Central Processing Unit (CPU), or in the memory 1423 or the storage 1428. Each of the memory 1423 and the storage 1428 may be any of various types of volatile or nonvolatile storage media. For example, the memory may include Read Only Memory (ROM) 1424 or Random Access Memory (RAM) 1425.

At least one module of the library loading detection apparatus 100 may be stored in the memory 1423, or may be configured to be executed by the at least one processor 1421. The function of the library loading detection apparatus 100, which is related to the communication of data or information, may be performed via the network interface 1429.

The method according to the embodiment may be implemented as a program that can be executed by various computer means. In this case, the program may be recorded on a computer-readable storage medium. The computer-readable storage medium may include program instructions, data files, and data structures solely or in combination. Program instructions recorded on the storage medium may have been specially designed and configured for the present disclosure, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

In accordance with the present disclosure, there are provided a method and apparatus that detect a potential binary preloading vulnerability in advance and notify a user of the detected potential binary preloading vulnerability.

Also provided are a method and apparatus that eliminate a potential binary preloading vulnerability via the deletion of a DLL and the unloading of a DLL.

As described above, although the embodiments have been described with reference to a limited number of embodiments and drawings, those skilled in the art will appreciate that various changes and modifications are possible from the above descriptions. For example, even if the above-described technologies are performed in a sequence differing from that of the described method, and/or components such as a system, a structure, a device, and a circuit are coupled or combined in a way differing from that of the described method or are replaced with or substitute other components or equivalents, suitable results can be achieved.

Therefore, it should be understood that other embodiments and examples and equivalents of the accompanying claims belong to the scope of the accompanying claims.

What is claimed is:

1. A method for detecting loading of a library, comprising:
monitoring loading of a binary;
detecting a duplicate Dynamic Link Library (DLL) or a nonexistent DLL that does not exist in a file path among one or more DLLs to be loaded by the binary; and
processing the duplicate DLL or the nonexistent DLL.

2. The method of claim 1, further comprising determining whether the binary loads a DLL,
wherein detecting and processing are performed when the binary is a library that loads a DLL.

3. The method of claim 1, wherein detecting the duplicate DLL or the nonexistent DLL comprises:
generating a list of the one or more DLLs by analyzing the binary; and
collecting file paths in which each DLL in the list exists; and
if the DLL exists in two or more file paths, selecting the DLL as the duplicate DLL.

4. The method of claim 3, wherein:
the duplicate DLL is classified into a normal duplicate DLL and an abnormal duplicate DLL, and
if the DLL exists in two or more file paths and is a normal system duplicate file, the DLL is a normal duplicate DLL.

5. The method of claim 4, further comprising updating a list of normal system duplicate files via interaction with an update server.

6. The method of claim 3, wherein:
the duplicate DLL is classified into a normal duplicate DLL and an abnormal duplicate DLL, and
if the DLL exists in two or more file paths and all of the two or more file paths are normal system duplicate paths, the DLL is a normal duplicate DLL.

7. The method of claim 6, further comprising updating a list of normal system duplicate paths via interaction with an update server.

8. The method of claim 3, wherein:
the duplicate DLL is classified into a normal duplicate DLL and an abnormal duplicate DLL, and
if the DLL is not a normal system duplicate file, and at least one of the two or more file paths in which the DLL exists is not a normal system duplicate path, the DLL is an abnormal duplicate DLL.

9. The method of claim 3, wherein the file paths in which it is checked whether the DLL exists comprise system check paths.

10. The method of claim 9, further comprising updating a list of the system check paths via interaction with an update server.

11. The method of claim 1, wherein detecting the duplicate DLL or the nonexistent DLL comprises:
generating a list of one or more DLLs by analyzing the binary;
collecting file paths in which each DLL in the list exists; and
selecting the DLL as the nonexistent DLL if any file path in which the DLL exists is not collected.

12. The method of claim 1, wherein processing the duplicate DLL or the nonexistent DLL comprises deleting the duplicate DLL or the nonexistent DLL that does not exist in any file path.

13. The method of claim 12, wherein processing the duplicate DLL or the nonexistent DLL comprises:
outputting information about the duplicate DLL or the nonexistent DLL; and
receiving a request to delete the duplicate DLL or the nonexistent DLL.

14. A method for detecting loading of a library, comprising:
monitoring loading of a binary;
detecting an unused Dynamic Link Library (DLL) among one or more DLLs to be loaded by the binary; and
processing the unused DLL,
wherein the unused DLL is a library that does not have functions called by the binary.

15. The method of claim 14, wherein detecting the unused DLL comprises determining a certain DLL to be the unused DLL if any of one or more functions to be used by the binary is not present in the certain DLL.

16. The method of claim 15, wherein the one or more functions to be used by the binary are functions actually called by the binary.

17. The method of claim 14, wherein processing the unused DLL comprises unloading the unused DLL.

18. The method of claim 17, wherein processing the unused DLL further comprises:
outputting information about the unused DLL; and
receiving a request to unload the unused DLL.

19. An apparatus for detecting loading of a library, comprising:
a binary loading monitoring unit for monitoring loading of a binary; and
a first DLL filtering unit for detecting a duplicate DLL or a nonexistent DLL that does not exist in a file path among one or more DLLs to be loaded by the binary, and processing the duplicate DLL or the nonexistent DLL.

20. The apparatus of claim 19, further comprising a second DLL filtering unit for detecting an unused DLL among the one or more DLLs and processing the unused DLL.
